(19) United States
(12) Patent Application Publication
(10) Pub. No.: US 2017/0060108 A1
(43) Pub. Date: Mar. 2, 2017

(54) ROI BASED AUTOMATION RECOMMENDATION AND EXECUTION

(71) Applicant: AUTOMATION ANYWHERE, INC., San Jose, CA (US)

(72) Inventors: Abhijit Kakhandiki, San Jose, CA (US); Sridhar Gunapu, Santa Clara, CA (US)

(73) Assignee: Automation Anywhere, Inc., San Jose, CA (US)

(21) Appl. No.: 15/351,615

(22) Filed: Nov. 15, 2016

Related U.S. Application Data
(63) Continuation-in-part of application No. 14/939,715, filed on Nov. 12, 2015.
Application No. 14/939,715 is a continuation-in-part of application No. 14/834,773, filed on Aug. 25, 2015.
Application No. 14/834,773 is a continuation-in-part of application No. 13/925,522, filed on Jun. 24, 2013, now Pat. No. 9,462,042.
Application No. 13/925,522 is a continuation-in-part of application No. 12/787,469, filed on May 26, 2010, now Pat. No. 8,504,803.
(60) Provisional application No. 62/409,444, filed on Oct. 18, 2016.
(60) Provisional application No. 62/258,601, filed on Nov. 23, 2015.

(51) Int. Cl. G05B 13/04

(52) U.S. Cl. CPC G05B 13/048; G05B 2219/23005; G05B 2219/35499

(57) ABSTRACT

This invention relates to a process, system and computer code to sequence processes to automate based on return on investment or ROI. The process and system divides considers the mix of human and robotic steps to optimize cost, quality and cycle-time of the process; classifying a process based on an entity and corresponding divisional partition, such as one of a group, department or stakeholder, and (2) generating key criteria; categorizing the ROI; applying constraints such as one of (a) cost, (b) quality or cycle-time; comparing one of (a) the human entered data, (b) the robot entered data, (c) the bot acquired data, with respect to one (i) cost, (ii) quality or (iii) cycle-time; queuing one of (a) a human task, (b) a robot task, or (c) a bot constructed task; storing one of (a) tracking process changes, (b process details and constraints in the event of a change.

### CROSS-REFERENCE TO RELATED APPLICATIONS

This is a continuation-in-part of and claims the priority benefit under35 U.S.C. 119 for U.S. patent application Ser. No. 62/409,444 entitled System And Method For Data Profile Driven Analytics, filed Oct. 18, 2016; and 35 U.S.C. 119 for U.S. patent application Ser. No. 62/258,601 entitled ROI Based Automation Recommendation And Execution, filed Nov. 23, 2015, and the priority benefit under 35 U.S.C. 120 for U.S. patent application Ser. No 14/939,715, entitled Artificial Intelligence & Knowledge Based Automation Enhancement, filed, Nov. 12, 2015 and the priority benefit under 35 U.S.C. 120, Ser. No. 62/160,655, entitled System And Method For Compliance Based Automation, filed May 13, 2015; and 35 U.S.C. 120 for U.S. patent application Ser. No. 62/130,068 entitled System And Method For Upgrade Resilient Automation, filed Mar. 09, 2015; and Ser. No. 14/834,773, entitled System And Method For Resilient Automation, filed Aug. 25, 2015; and under 35 U.S.C. 120 for U.S. Pat. No. 9,462,042 entitled System And Method For Enabling Application Discovery By Automation Needs, issued Oct. 4, 2016; and under 35 U.S.C. 120 for U.S. Pat. No. 8,504,803 System and Method For Creating and Executing Portable Software, the entire disclosures of which are hereby incorporated by reference herein.

### FIELD OF THE INVENTION

The present invention relates to information technology software to determine the appropriate sequence of processes to automate based on projected return on investment (ROI).

### BACKGROUND OF THE INVENTION

End users of Web task, legacy applications, Apple (Apple is a registered trade mark of Apple, Inc.) or Windows (Windows is a registered trade mark of Microsoft Corporation) based operating systems create few automated processes, that is a series of steps that a user desires to execute on a computer (often at pre-defined time or with a click of a button or a mouse). These software processes could be of any type and for any purpose, e.g., business, IT, or requirements to validate software behavior, etc. In some instances, the user desires to create a task, assign properties to the task and to run the task on a local or a remote computer. Desirable applications may be the creation of adapters that enable application automation by collecting automation information; the locating of application controls and tracking changes between an older and newer version of an application; presenting the changes using an exception management model to a user, so that the user can provide feedback in a visual, instead of programmatic manner; storing and incorporating the changes so as to make the adapters are made resilient to application changes and upgrades.

Traditional automation techniques are limited in their ability to perform automation tasks perfectly and reliably, since they do not have prior knowledge of the system and application conditions built in. Additionally, the current processing load is often never considered in determining system response, which can be critical in reliably automating tasks on that system. Significant improvements in automation can be achieved by targeting the precise processes to automate in the a predetermined sequence. Determining the precise processes to automate can lead to higher cost savings and improved efficiency in less time as compared to ad-hoc process automation.

### SUMMARY OF THE INVENTION

The disclosure herein relates to a system and method to determine the appropriate sequence of processes to automate based on projected return on investment (“ROI”) as applied to such efforts as computer programming activities. Additionally the inventive system and method divides the process into an optimum mix of human and robotic automation of the activities to minimize cost, increase quality and improve on the cycle-times of the affected computer processes.

An overview of an embodiment of the disclosed invention includes: categorizing ROI, as it relates to automating a functional computer process, via leveraging an existing database of past automation ROI realized by a customer computer; evaluating a specific automation ROI for a given process based on total number of full time equivalents (“FTEs”) employees, location, skillset requirements, and cost to replace/help FTEs; dividing a process into essential steps based on: (a) the entity performing the work, (b) where the work is being performed etc.; comparing a human FTE cost to machine cost to determine an optimal option to perform the work; accounting for service level agreements (“SLA”), work duration and quality requirements, to place tasks in a unified queue for humans, robots and related entities such as software bots; reprioritizing a task creating portable automation criteria libraries (correlated to a system with a specific automation profile) that can be leveraged on new systems with comparable automation profiles thus providing near-perfect and reliable automation of the work effort, out-of-the-box.

Another embodiment of the invention includes a computer method for automating a computer process based on a return on investment, including the steps of: (1) creating an execution file having one or more tasks having command line arguments executable as widgets by the computer, assembled into an execution file, which includes nested tasks; (2) organizing the nested task related to each task; (3) accounting for all dependencies to insure that files, tasks, and environments for running on the computer are present in the execution file; (4) the step of creating an execution file further including: (a) reading the task file, (b) scanning for event dependencies, and (c) embedding files and links needed for execution of the execution file, (d) storing the dependencies in a dependency file, and (e) accessing a functional process analyzer, evaluating specific automation return on investment for a computer process, based on one or more of a total number of FTE employees, employee location, employee skillset requirements, and cost to replace or help full time equivalents; (f) dividing the computer process into constituent steps based on: (5) the entity performing the work, (6) where the work will be performed; (7) comparing a human full time equivalent costs to a machine cost to determine an optimal option to accomplish the work; (8) accounting for SLAs, work duration and quality requirements to place tasks in a unified queue for humans, robots and related entities such as software bots; (9) reprioritizing task for creating portable automation criteria libraries; (10) correlating to a system with a specific automation profile, that leveraging on computer processes with comparable automation profiles, for providing optimum and reliable automation for out-of-the-box software.

Yet another embodiment of the invention is a computer system for automating a computer process based on a return on investment, including: (A) a functional process analyzer for (1) classifying a process based on an entity and a corresponding divisional partition, such as one of a group, department or stakeholder, and (2) generating key criteria, such as a (a) process automation index, or (b) a process complexity index, based on (i) workforce parameter, (ii) a required skill, (iii) a workforce location, or (iv) a process duration; (B) a return on investment modeler for: (1) computing and categorizing the return on investment into (a) a measurement based on earlier in time customer automation return on one of (i) investment data by industry or (ii) dependent on predefined categorizations based on (a) vertical organization or (ii) a process category; (C) a functional process optimizer for (1) applying constraints such as one of (a) cost, (b) quality or cycle-time, in order to determine the optimal steps for the return on investment process; and (c) determining the optimum resource to carry out the return on investment process by a (i) human, (ii) a robot or (iii) bot; (D) a criteria comparison engine for (1) comparing one of (a) the human entered data, (b) the robot entered data, (c) the bot acquired data, with respect to one (i) cost, (ii) quality or (iii) cycle-time; (E) a unified queue modeler for: (1) queuing one of (a) a human task, (b) a robot task, or (c) a bot constructed task, based on (i) the functional process optimizer, or (ii) and evaluation of any changes in process details such as by one of (d) workforce, (e) required skills, (f) workforce location, (g) process duration, and (h) process constraints such as one of (j) cost, (k) quality factors, or (1) cycle-time, and for: (2) re-prioritizes the unified queue in real-time; (F) and update mechanism for: (1) storing (a) a track of process changes, (b process details and constraints in the event of a change; (2) initializing a plurality of key parameters for a next set of values and changes in benchmarking ratios.

### BRIEF DESCRIPTION OF THE DRAWINGS

FIG. 1 shows a system for a service provider computer system for creating one or more application execution files in accordance with an embodiment of the present invention.

FIG. 2 shows a set of modules for an application automation process in accordance with an embodiment of the present invention.

FIG. 3 shows a process for a system an application automation process in accordance with an embodiment of the present invention.

FIG. 4 shows a process for a system an application automation process in accordance with an embodiment of the present invention.

### DESCRIPTION OF PREFERRED EMBODIMENT

The invention will now be described more fully hereinafter with reference to the accompanying drawings, in which preferred embodiments of the invention are shown. This invention may be embodied in many different forms and should not be construed as limited to the embodiments set forth herein. Rather, these embodiments are provided so that this disclosure will be thorough and complete, and will fully convey the scope of the invention to those skilled in the art Like numbers refer to like elements throughout. In what follows, application software refers to all the computer software that causes a computer to perform useful tasks beyond the running of the computer itself. The disclosure relates to software, which manages and integrates a computer's capabilities, such as the generation of adapters to enable application automation by exposing operations that can be automated, in the form of an API that can be leveraged by various automation engines including Automation Anywhere (found at www.automationanywhere.com).

U.S. Pat. No. 8,504,803 entitled System and Method for Creating and Executing Portable Software, incorporated by reference herein, deals with the creation of commands having single execution features or as part of a several line operation or one of several commands that serves as an application for the inventive features of the process described herein. The present disclosure deals more specifically with an inventive process for executing applications related to optimizing return on investments for a service provider environment, operating in and outside of a communication channel, such as the Internet or a direct connection to a customer computer, via installed software or direct connection via hard wire to a customer computer, in either case requiring updated applications for the customer computer, generally referred throughout as a computer-to-be-updated, or a customer computer or environment, while generally adhering to the customer's compliance boundary requirements.

The tasks in the service provider environment have one or more of a series of tasks having commands, and other instructions having variables, executable by an application in the computer-to-be-updated. In one embodiment of the invention, the service provider computer assembles tasks into execution files, which may require validating the tasks and organizing nested tasks, including collecting nested task information for each task, and accounting for all dependencies to insure that files, tasks, and environments for running on one or more computer-to-be-updated computers are present. At least one or more dependencies will, subject to a computer-to-be-updated set of compliance boundary parameters, enable a service provider to create specific adapters that enable an automated application to be executed, when the adapters are incorporated into the computer-to-be-updated.

The creation of an execution file may include reading the task file, scanning for event dependencies and embedding files and links needed for the remote execution of the execution file, storing the dependencies in a dependency file, scanning for security, such as insuring the customer's compliance boundary parameters are present and functional, and verifying the task file for proper formatting. In the inventive process, the service provider is presumed to have access via a remote access technology, to deliver the elements of code, while respecting the compliance parameters, required for communicating between two or more computer environments.

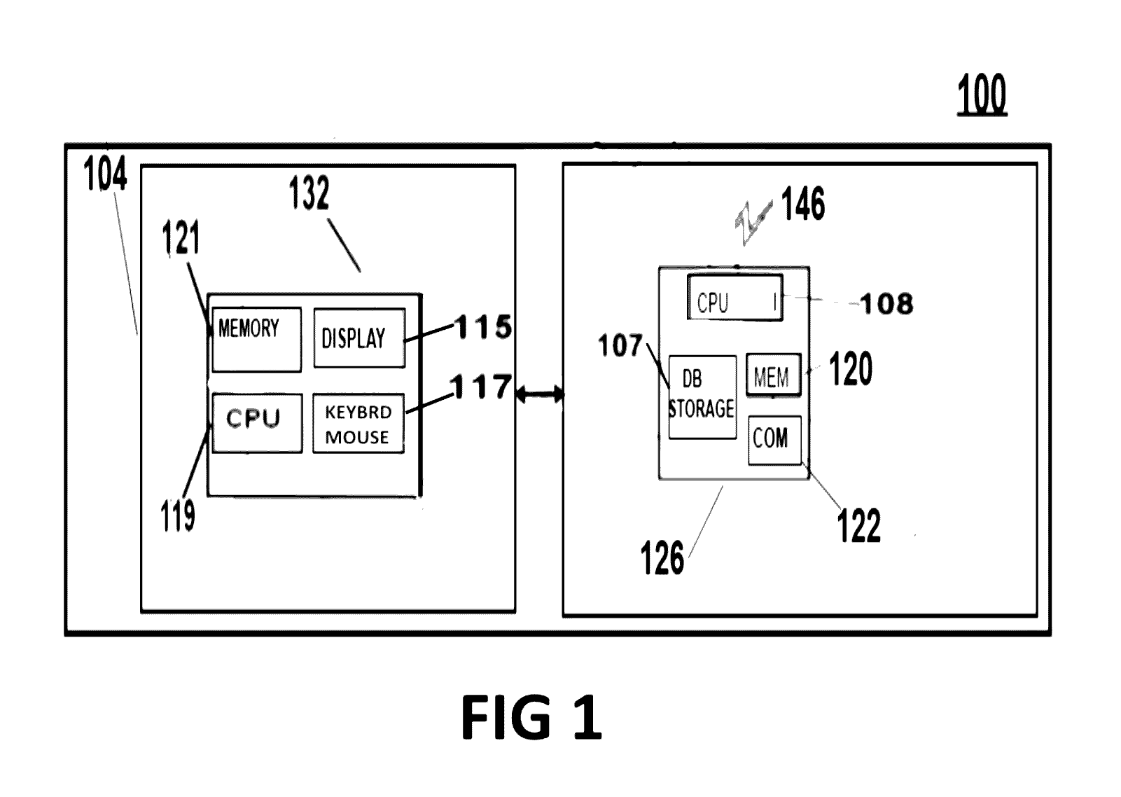

FIG. 1 represents a service provider computer system 100, which includes computer 132 and server 126. Computer 132 has at least one central processing unit (CPU) 119, which typically is the processor for executing an operating system residing in memory 121. Computer 132 also operates a display 115 and an input device 117. The computer 132 has the facility to access other computers, such as server 126. The server 126 has at least one central processing unit (CPU) 108, which typically is the processor for an operating system and an application resident in memory 120, and communicates with and contains a database storage unit 107, as well as a means for communication 122 that can access the Internet 146.

The computer system 100 may further include a plurality of remote computers (not shown) and further by way of example and not limitation, to a plurality of mobile personal data assistants, tablets and smartphones (not shown) that may access the server 126 and operate the processes disclosed herein.

The system 100 may be configured in many different ways. For example, server 126 may be a conventional standalone server computer or alternatively, the function of server may be distributed across multiple computing systems and architectures. Server 126 may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to communications ports that serve as a communication link with other servers, client or user computers. A variety of communications protocols may be part of the system, including but not limited to: Ethernet, SAP, SAS.™., ATP, Bluetooth, GSM and TCP/IP.

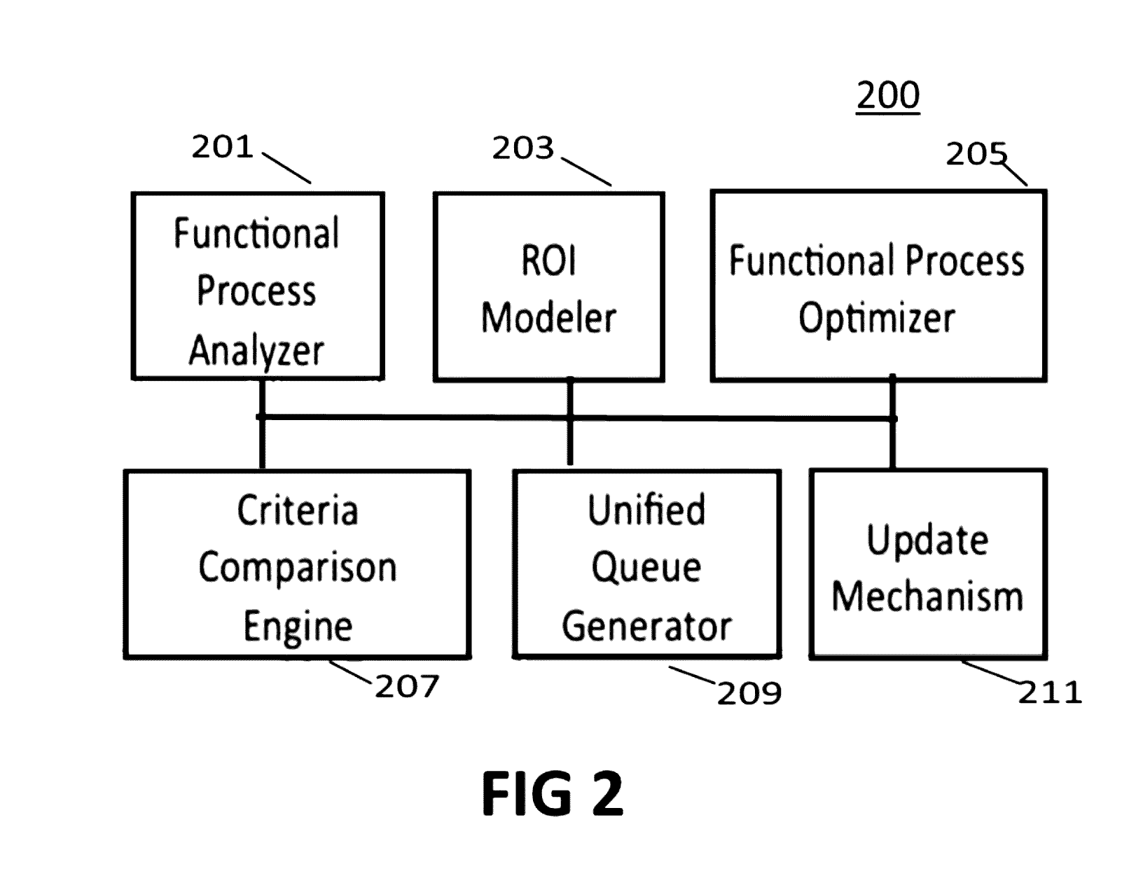

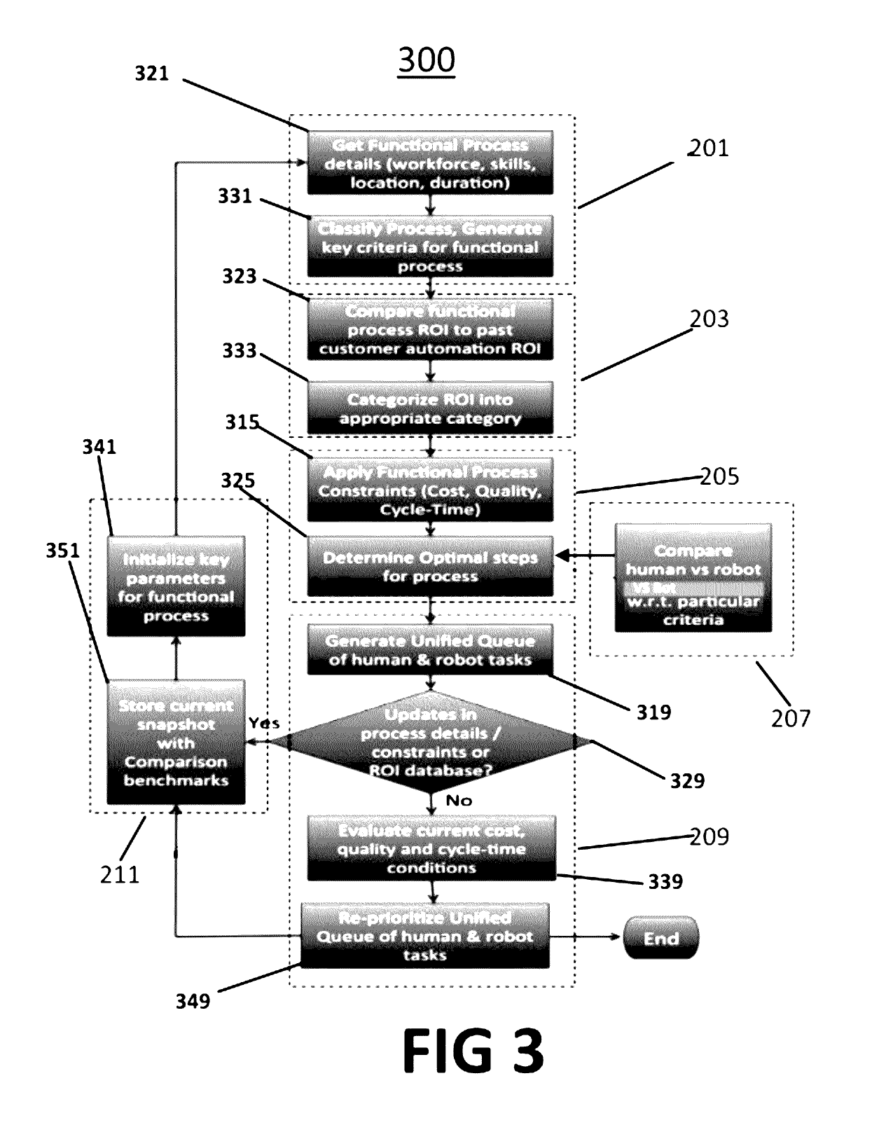

The data storage device 107 may store, for example, (i) program code for creating, executing and porting the software, as more fully described in connection with FIG. 2 and FIG. 3, to update the code in a customer's remote computer processor 152 in accordance with the present invention. More particularly data storage device 107 operates in accordance with a process for creating, executing and porting the software necessary to achieve updating a remote computer, such as embodied in computer system 150, and to achieve the novelty of the invention.

The program for creating, executing and exporting the return on investment portable software may be stored, for example, in a compressed, an uncompiled and/or an encrypted format, and may include computer program code. The program may include user generated macros that contain instructions to record and playback executable programs after having been deployed via a remote computer access program to the computer-to-be-updated.

While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

The term “computer-readable medium” as used herein refers to any medium that provides or participates in providing instructions to the computer 132 of the computing device (or any other processor of a device described herein) for execution and more particularly for creating, executing and porting the portable software. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

By way of example, various forms of computer readable media may be involved in carrying one or more sequences of one or more instructions to the computer 132 utilized in system 100, (or any other processor of a device described herein) for creating, executing and porting the portable software. For example, the instructions may initially be instantiated on a magnetic disk of a remote computer. The remote computer can load the instructions into its dynamic memory and send the instructions over an Ethernet connection, cable line, or even telephone line using a modem. A communications device local to a computing device (or, e.g., a server, such as communication module 122) can receive the data on the respective communications line and place the data on a system bus for the processor. The instructions received by main memory may optionally be stored in memory either before or after execution by the processor. In addition, instructions may be received via communication module 122 and associated port as electrical, electromagnetic or optical signals, which are exemplary forms of wireless communications or data streams that carry various types of information.

The service provider in fulfilling its provision of the return on investment services, in accordance with the embodiment of the invention, seeks automatically, i.e., with little or no human intervention, to create an application to update a computer-to-be-updated such that it performs in accordance with the objects of the invention herein described.

This disclosure further relates to a computer method for creating the appropriate sequence of processes to automate a computer process based on a ROI, including the steps of: (1) creating an execution file having one or more tasks having command line arguments executable as widgets by the computer, assembled into an execution file, which includes nested tasks; (2) organizing the nested task related to each task; (3) accounting for all dependencies to insure that files, tasks, and environments for running on the computer are present in the execution file; (4) the step of creating an execution file further including, (a) reading the task file, (b) scanning for event dependencies, and (c) embedding files and links needed for execution of the execution file, (d) storing the dependencies in a dependency file, and (e) accessing a functional process analyzer, evaluating specific automation ROI, for a given process based on one or more of a total number of FTE employees, location, skillset requirements, and cost to replace/help FTE employees; dividing the computer process into constituent steps based on: (1) the entity performing the work, (2) where the work will be performed; comparing a human FTE cost to a machine cost to determine optimal option to accomplish the work; accounting for SLA, work duration and quality requirements to place tasks in a unified queue for humans, robots, and software bots; reprioritizing task creating portable automation criteria libraries, correlating to a system with a specific automation profile that can be leveraged on new computer processes with comparable automation profiles to provide optimum and reliable automation out-of-the-box software.

FIG. 2 represents a non limiting system containing functional modules 200 that interconnect and perform in accordance with the definitions to follow and apply the inventive process in accordance with the definitions of the modules are as follows:

Functional Process Analyzer: The functional process analyzer 201 classifies a process based on functional process details, such as: an entities divisional partitions, such as groups, departments and stakeholders, involved and business objectives that the process aims to satisfy the objects of the entity. The functional process analyzer 201 also generates key criteria such as a (1) process automation index and (2) a process complexity index, based on workforce, skills required, their location, and process duration (cycle-time).

ROI Modeler: The ROI modeler 203 computes and categorizes the process ROI into appropriate categories, such as by way of example and not limitation a measure of very high, high, medium, low, very low, by accessing results of past customer automation ROI data by industry, dependent on predefined categorizations such as by way of example and not limitation, (1) vertical organization and (2) process category.

Functional Process Optimizer: The functional process optimizer 205 applies functional process constraints such as by way of example and not limitation, cost, quality and cycle-time in order to determine the optimal steps for the process. It also determines the optimum resource to carry out the process step, by way of example and not limitation, human, robot or related entity such as a software bot.

Criteria Comparison Engine: The criteria comparison engine 207 compares human and robot data with respect to various criteria, such as by way of example and not limitation cost, quality and cycle-time.

Unified Queue Modeler: The unified queue modeler 209 is a unified queue of human and robot tasks based on the functional process optimizer. It evaluates any changes in process details such as by way of example and not limitation: (a) workforce, skills required, their location, process duration; (b) process constraints such as cost, quality & cycle-time; and (c) re-prioritizes the unified queue in real-time.

Update Mechanism: The update mechanism 211 provides a data storage to keep track of all process changes. It stores the current snapshot of process details and constraints in the event of a change, and initializes the key parameters for the next set of values to store. This includes changes in benchmarking ratios with respect to customer automation ROI database as well.

Utilizing the functional components 200 as described in FIG. 2, one non limiting embodiment of the invention is a process 300, which includes the following steps: A. utilizing the functional processor analyzer 201 for obtaining functional process details 321; B. utilizing the functional process details for establishing 331, (1) a classification and (2) a generation of key criteria; C. utilizing the ROI modeler for (1) comparing 323 a functional process ROI to past customer automation ROI and (2) categorizing 333 ROI into an appropriate category; D. utilizing the process optimizer 205 for applying functional process constraints 315 and (2) for determining optimal steps for the process 325; E. utilizing the compare human versus robot 207 function as input to the determine optimal steps for process 325; F. utilizing the unified queue modeler 209 for generating 319 unified queue of human robots, and software robot tasks; and testing 329 if the updates in process details/constraints or ROI databases. If the test yields a “no”, then the process 300 evaluates 339 current cost, quality and cycle time conditions and reprioritizes 349 the unified queue of human and robot tasks. If the test yields a “yes” then the process proceeds to the update mechanism 211 to store 351 a snapshot with comparison benchmarks. Likewise the reprioritize 349 also proceeds to the update mechanism 211 to store 351 a snapshot with comparison benchmarks the updates. Once the snapshot is stored 351 the process initializes 341 the parameters for the functional process and starts over. The process also has the option of ending.

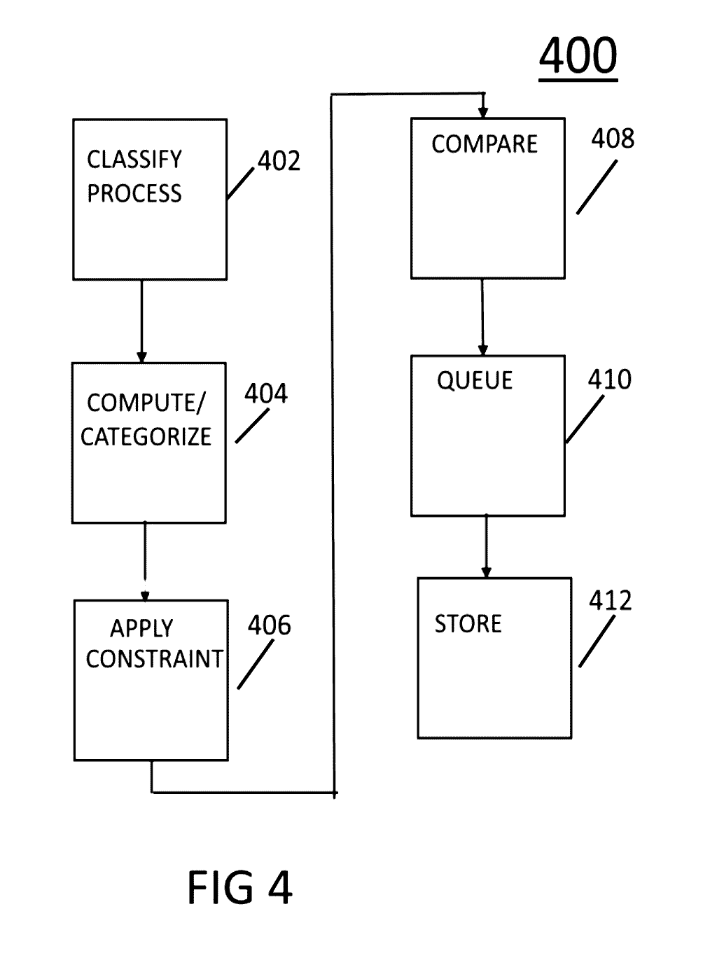

One non limiting embodiment of the invention a depicted in FIG. 4, includes a computer process 400 based on a return on investment, (a) including classifying a process 402 based on an entity and corresponding divisional partition; (b) computing and categorizing the return on investment 404; (c) applying constraints 406 such as one of (i) cost, (ii) quality or (iii) cycle-time, in order to determine the optimal steps for the return on investment process, and (iv) determining the optimum resource to carry out the return on investment process by one of a (i) human, (ii) a robot or (iii) bot; (d) comparing 408 one of (i) the human entered data, (ii) the robot entered data, (iii) the bot acquired data, with respect to one (x) cost, (y) quality or (z) cycle-time; (e) queuing 410 one of (i) a human task, (ii) a robot task, or (iii) a bot constructed task; (f) storing 412 one of (i) tracking process changes, (ii) process details and constraints in the event of a change; (2) initializing a plurality of key parameters for a next set of values and changes in benchmarking ratios.

More particularly the non limiting embodiment of the invention illustrated in FIG. 4 includes a computer process based on a return on investment, including (A) (1) classifying a process based on an entity and corresponding divisional partition, such as one of a group, department or stakeholder, and (2) generating key criteria such as one of a (a) process automation index, or (b) a process complexity index, based on one of (i) workforce parameter, (ii) a required skill, (iii) a workforce location, or (iv) a process duration; (B) (1) computing and categorizing the return on investment into one of (a) a measurement based on earlier in time customer automation return on one of (i) investment data by industry or (ii) dependent on predefined categorizations based on one of (a) vertical organization or (ii) a process category; (C) (1) applying constraints such as one of (a) cost, (b) quality or cycle-time, in order to determine the optimal steps for the return on investment process; and (c) determining the optimum resource to carry out the return on investment process by one of a (i) human, (ii) a robot or (iii) bot; (D) (1) comparing one of (a) the human entered data, (b) the robot entered data, (c) the bot acquired data, with respect to one (i) cost, (ii) quality or (iii) cycle-time; (E) (1) queuing one of (a) a human task, (b) a robot task, or (c) a bot constructed task, based on one of (i) the functional process optimizer, or (ii) and evaluation of any changes in process details such as by one of (d) workforce, (e) required skills, (f) workforce location, (g) process duration, and (h) process constraints such as one of (j) cost, (k) quality, or (1) cycle-time, and for: (2) re-prioritizes the unified queue in real-time; (F) (1) storing one of (a) tracking process changes, (b process details and constraints in the event of a change; (2) initializing a plurality of key parameters for a next set of values and changes in benchmarking ratios.

While the present invention has been described with reference to the illustrative embodiments, this description is not intended to be construed in a limiting sense. Various modifications of the illustrative embodiments, as well as other embodiments of the invention, will be apparent to those skilled in the art in reference to this description. It is expressly intended that all combinations of those elements that perform substantially the same function in substantially the same way to achieve the same results are within the scope of the invention. Substitutions of elements from one described embodiment to another are also fully intended and contemplated. It is therefore contemplated that the appended claims will cover any such modifications or embodiments as fall within the true scope of the invention.

We claim:

1. A computer method for automating a computer process based on a return on investment, comprising the steps of: (1) creating an execution file having one or more tasks having command line arguments executable as widgets by the computer, assembled into an execution file, which includes nested tasks; (2) organizing the nested task related to each task; (3) accounting for all dependencies to insure that files, tasks, and environments for running on the computer are present in the execution file; (4) the step of creating an execution file further including: (a) reading the task file, (b) scanning for event dependencies, and (c) embedding files and links needed for execution of the execution file, (d) storing the dependencies in a dependency file, and (e) accessing a functional process analyzer, evaluating specific automation return on investment, for a computer process based on one or more of a total number of full time equivalent employees, employee location, employee skillset requirements, and cost to replace or help full time equivalents; (f) dividing the computer process into constituent steps based on: (5) the entity performing the work, (6) where the work will be performed; (7) comparing a human full time equivalent costs to a machine cost to determine optimal option to accomplish the work; (8) accounting for service level agreements, work duration and quality requirements to place tasks in a unified queue for one of humans, robots or software bots; (9) reprioritizing task for creating portable automation criteria libraries; (10) correlating to a system with a specific automation profile, that leveraging on computer processes with comparable automation profiles, for providing optimum and reliable automation for out-of-the-box software.

2. A computer system for automating a computer process based on a return on investment, comprising (A) a functional process analyzer for (1) classifying a process based on an entity and corresponding divisional partition, such as one of a group, department or stakeholder, and (2) generating key criteria such as one of a (a) process automation index, or (b) a process complexity index, based on one of (i) workforce parameter, (ii) a required skill, (iii) a workforce location, or (iv) a process duration; (B) a return on investment modeler for: (1) computing and categorizing the return on investment into one of (a) a measurement based on earlier in time customer automation return on one of (i) investment data by industry or (ii) dependent on predefined categorizations based on one of (a) vertical organization or (ii) a process category; (C) a functional process optimizer for (1) applying constraints such as one of (a) cost, (b) quality or cycle-time, in order to determine the optimal steps for the return on investment process; and
(c) determining the optimum resource to carry out the return on investment process by one of a (i) human, (ii) a robot or (iii) bot; (D) a criteria comparison engine for (1) comparing one of (a) the human entered data, (b) the robot entered data, (c) the bot acquired data, with respect to one (i) cost, (ii) quality or (iii) cycle-time; (E) a unified queue modeler for: (1) queuing one of (a) a human task, (b) a robot task, or (c) a bot constructed task, based on one of (i) the functional process optimizer, or (ii) and evaluation of any changes in process details such as by one of (d) workforce, (e) required skills, (f) workforce location, (g) process duration, and (h) process constraints such as one of (j) cost, (k) quality, or (1) cycle-time, and for: (2) re-prioritizes the unified queue in real-time, (F) and update mechanism for: (1) storing one of (a) tracking process changes, (b process details and constraints in the event of a change; (2) initializing a plurality of key parameters for a next set of values and changes in benchmarking ratios.

3. The computer system in claim 2 wherein: classifying a process based on an entity and corresponding divisional partition, includes one of a group, department or stakeholder.

4. The computer system in claim 2 wherein: generating key criteria includes such as one of (a) a process automation index, or (b) a process complexity index.

5. The computer system in claim 4 wherein: the process complexity index includes one of (i) workforce parameter, (ii) a required skill, (iii) a workforce location, or (iv) a process duration.

6. The computer system in claim 2 wherein: a return on investment modeler computes and categorizes the return on investment into one of (a) a measurement based on earlier in time customer automation return on one of (i) investment data by industry or (ii) dependent on predefined categorizations based on one of (a) vertical organization or (ii) a process category.

7. The computer system in claim 2 wherein: the functional process optimizer includes (1) applying constraints such as one of (a) cost, (b) quality or cycle-time, in order to determine the optimal steps for the return on investment process; and (c) determining the optimum resource to carry out the return on investment process by one of a (i) human, (ii) a robot or (iii) bot.

8. The computer system in claim 2 wherein: a criteria comparison engine compares one of (a) the human entered data, (b) the robot entered data, (c) the bot acquired data, with respect to one (i) cost, (ii) quality or (iii) cycle-time.

9. The computer system in claim 2 wherein: a unified queue modeler queues one of (a) a human task, (b) a robot task, or (c) a bot constructed task, based on one of (i) the functional process optimizer, or (ii) and evaluation of any changes in process details such as by one of (d) workforce, (e) required skills, (f) workforce location, (g) process duration, and (h) process constraints such as one of (j) cost, (k) quality, or (1) cycle-time, and for: (2) re-prioritizes the unified queue in real-time.

10. The computer system in claim 2 wherein: the update mechanism (1) stores one of (a) tracking process changes, (b process details and constraints in the event of a change; (2) initializes a plurality of key parameters for a next set of values and changes in benchmarking ratios.

11. A computer process based on a return on investment, comprising the steps of: (A) (1) classifying a process based on an entity and corresponding divisional partition, such as one of a group, department or stakeholder, and (2) generating key criteria such as one of a (a) process automation index, or (b) a process complexity index, based on one of (i) workforce parameter, (ii) a required skill, (iii) a workforce location, or (iv) a process duration; (B) computing and categorizing the return on investment into one of (a) a measurement based on earlier in time customer automation return on one of (i) investment data by industry or (ii) dependent on predefined categorizations based on one of (a) vertical organization or (ii) a process category; (C) applying constraints such as one of (a) cost, (b) quality or cycle-time, in order to determine the optimal steps for the return on investment process; and (c) determining the optimum resource to carry out the return on investment process by one of a (i) human, (ii) a robot or (iii) bot; (D) comparing one of (a) the human entered data, (b) the robot entered data, (c) the bot acquired data, with respect to one (i) cost, (ii) quality or (iii) cycle-time; (E) queuing one of (a) a human task, (b) a robot task, or (c) a bot constructed task, based on one of (i) the functional process optimizer, or (ii) and evaluation of any changes in process details such as by one of (d) workforce, (e) required skills, (f) workforce location, (g) process duration, and (h) process constraints such as one of (j) cost, (k) quality, or (1) cycle-time, and for: (2) re-prioritizes the unified queue in real-time; (F) (1) storing one of (a) tracking process changes, (b process details and constraints in the event of a change; (2) initializing a plurality of key parameters for a next set of values and changes in benchmarking ratios.
